(19) United States
(12) Patent Application Publication
(10) Pub. No.: US 2005/0231392 A1
(43) Pub. Date: Oct. 20, 2005

(54) System and method for representation of business information

(76) Inventors: Andrew Michael Meehan, Harbord (AU); Socrates Cappas, Mosman (AU)

Correspondence Address: LADAS & PARRY, 26 WEST 61ST STREET, NEW YORK, NY, 10023, US

(21) Appl. No.: 10/887,454

(22) Filed: Jul. 8, 2004

(30) Foreign Application Priority Data
Apr. 16, 2004 (AU) 2004201587

(51) Int. Cl. G08G 1/123

(52) U.S. Cl. 340/995.1

(57) ABSTRACT

A system and method generates a map representation of information from a BI (business intelligence) application. The BI information is used to generate map data, which in turn is used to generate a map representation. The system and method are arranged to generate the same thematics in a representation as provided by BI application. For example, if the BI information is information on crime in a particular area, the map representation will present the same theme in a spatial frame of reference, using similar metadata (thematic data) to express the theme on the map representation.

### FIELD OF THE INVENTION

The present invention relates to a system and method for generating a spatial representation of business information, and particularly, but not exclusively, to a system and method which enables analysis of business information to be performed between a spatial domain and a business intelligence application.

### BACKGROUND OF THE INVENTION

Business applications implemented by computing systems are vital to many organisations. Very broadly, business applications include any systems that store, present or otherwise process business data (BD). BD may include any data that is held by an organisation in a diverse set of data sources. Data sources are typically held on a wide variety of storage media including (but not limited to) magnetic or optical media. BD is most commonly held in a well defined structured form in databases, tabular files, emails, web pages, spreadsheet files and word processing documents. BD may also be unstructured or textual in nature.

Business applications include any computer implemented system which stores, presents or otherwise processes BD. For example, Business applications include data base management software, spreadsheets applications, analysis or business processing application, and including but not limited to word processing applications.

Business applications also include the more focused domains of Business Intelligence (BI).

BI applications enable easy and flexible access, presentation and analysis of BD that are related in one or more ways from one or more data sources. BI applications make it very easy to personalise how data can be made meaningful to specific individuals, viewpoints or business groupings. Data presented in a meaningful way is information. BI tools turn vast quantities of data granules into “golden nuggets” of information. For example, a set of simple numbers becomes a sales trend or an impending stock shortage or a bottle neck in a supply process. BI products from suppliers like Hyperion™, Cognos™, Business Objects™ and others allow organisations to draw on all of the available data that is required to gain insights into the workings of the organisation, either from a whole of business view or a very detailed and operationally focused perspective. BI applications allow one to perceive problems and exceptions and to then use the BI tool to act on that. BI tools provide the ability re-select the subject matter independently of its data source, re-arrange perspective, change display characteristics, eliminate unwanted detail and add missing details. It is this flexibility and interactivity that differentiates a BI application from the reporting aspects of a business application. BI applications therefore answer standard and arbitrary business questions in a much wider context. The value added output from BI applications can be termed BI information (BIF).

BI technologies are good at spanning multiple data sources, discovering trends and statistical patterns in tabular data. They are also good at representing data to business users in a form that is easy to understand such as charts, pivot tables and dashboards.

BI applications are not good at representing or detecting spatial trends or associations that may exist in the BD. In a database including information on properties (housing), for example, a BI tool cannot, for example, identify properties that are adjoining. How can it know that 35 Bay Street is adjacent to 546 Alfred Boulevard?

Geographical Information Systems (GIS) applications are able to generate maps and are designed to accurately represent the physical layout of the real world at both small and large scales. They are well suited to answering questions where location and relationships between locations are significant. For example, maps which include data such as plotted accident locations enable users to detect spatial associations and trends in accidents. Where are the accident black spots? Attributes of plotted data on maps are usually expressed using “thematic data”, such as displaying fatal accidents by coloured circles or shading locality areas based on the crime rate within the shaded boundaries. The thematic data illustrates the theme (eg crime, accidents, etc) being represented.

GIS usually operate by building maps from superimposed layers. Each layer generally holds some characteristic of interest. Layers can consist of spatial features such as streets, parks, postal districts, cities, features such as radio towers, rivers and so on. Each layer may deal with a particular feature of interest for example rivers, land, contours etc. The paradigm of constructing maps from superimposed layers is in fact one which has been known for many years and was long implemented manually before the advent of computers, and the paradigm has been continued by GIS applications. The GIS applications bring the power of computers to preparing map layers. In order to create a particular layer it is required to operate the GIS application to input map locations and create a data source that the GIS can use to implement the layer. This takes a significant amount of time and requires a specialist.

Typically, map layers contain one or more of three types of map feature. A point feature represents a position of a particular feature such as a radio tower, accident, current location of a vehicle. Line features represent the path taken by features such as roads, rail or flight paths. Polygon features represent closed areas such as property boundaries, high-pressure areas or the boundary representing a particular drive time to a point feature. In addition to this, abstract feature types such as a circle displaying a two-kilometre distance from a point may also be used. The spatial location of features can therefore be displayed as a dot/icon, a set of lines, or as a polygon or other enclosed shape.

Map users are also interested in other attributes of the features besides their location. They may be interested in the “type” of a point feature. Is it a car or truck? Which day of the week did the accident happen on? They may be interested in calculations determining characteristics of a polygon or line. What is the salinity level of the soil in a particular area? What type of road is this? Or they may be interested in characteristics of entities within a distance from a feature. What is the average income of people living within 5 km of a proposed shop location? Or what is the sum of estimated property values within 50 yards of a proposed road? This additional information is usually displayed on a map using some form of thematic data. For example, such extra information about point features may be displayed by using shapes, icons and colours as the thematic data. Line features can have representations such as thickness, style (double line, dashed etc) and colour to convey extra data. Shading using different colours or hatch patterns can convey attribute data associated with polygons or other closed shapes. Data windows that pop up when the users hover over a feature can also display extra data.

Maps are thus able to display information in a particular form which enables analysis from a spatial frame of reference. A problem is that the present process for creating the map layers using GIS applications is cumbersome. As discussed above, the GIS application essentially “computerises” what was previously a manually implemented paradigm. Specialist skill is still required to operate the GIS application and the specialist must input data and prepare a data source configuration for each map layer.

Further, GIS applications allow spatial analysis but do not offer the level of statistical or numerical data analysis that is provided by BI applications.

### SUMMARY OF THE INVENTION

In accordance with a first aspect, the present invention provides a system for generating a map representation of information from a business intelligence (BI) application, the system comprising map data generation means which is arranged to receive BI information from the BI application and to produce map data from the BI information, the map data being usable to generate a map representation of the BI information, which map representation may be displayed together with any base map data.

Preferably, the map data generation means is arranged to provide the map data to a map generator which is arranged to generate a map representation of the BI information, together with a map representation of any base data.

Preferably, the BI information is themed BI information. That is, the information is representative of a particular theme which may be presented by the BI application. The theme may be any theme eg accident black spots, crimes, property prices, etc. This provides the advantage that a theme being viewed by an interface with a BI application can also be viewed by a map representation, thereby providing a spatial frame of reference for the theme eg crime density in a particular area, property prices over a particular area, etc.

Preferably, the map generator is a Geographical Information System (GIS) application. In one embodiment, map data is generated from BI information and provided directly to a GIS application, which then generates a map layer. The map layer presents the BI information embodied in the map data in a spatial domain, and preferably overlaying a representation of base map data, which may include, for example, streets, postal districts, cities and other geographical information.

Preferably, the system further comprises interface means enabling a connection between the BI application and the map data generator, whereby any change in BI information produces resultant changes in map data, resulting in changes in the map representation. An operator may work on a BI application analysing the BI information, and any changes that are made as a result of the analysis may be translated to a corresponding change in the map representation.

The system of the present invention, therefore, preferably has the advantage that BI information from a business intelligence (BI) application can be presented in a spatial domain (the map representation), so that a user can view relationships, trends or associations in the spatial domain and obtain insights that they may not be able to from a BI application.

Preferably, the system further comprises a map manipulation means which is arranged to enable a user to manipulate the map representation of the BI information. The system of the present invention may implement the map manipulation means or may utilise map manipulation applications of available GIS applications. The manipulation may comprise selecting map representation data from the map representation, or selecting base map data. Preferably the map manipulation means is arranged to produce BI or spatial information from the manipulation, which BI or spatial information may be provided back to the BI application. Preferably an interface between the map manipulation means and the BI application enables BI data provided from the manipulation to be received by the BI application.

The system therefore has an advantage that, in preferred embodiments, the user may work both in the spatial domain (map representation and manipulation means) and in the BI application domain, and manipulations (which includes selection of data and changes to data) of the data in either domain are provided to the other domain. This enables, for example, analysis to take place in an iterative manner between both the spatial domain and the BI application domain. Spatial patterns may be observed and spatial constraints placed on the data in the spatial domain. Manipulated data can then be sent back to the BI application for further analysis. This creates a virtuous circle where each iteration between the domains takes the analyst closer to their final analysis goal.

Preferably, the system of the present invention further includes a data selection means, the data selection means being arranged to select BI information from the BI application to be provided to the map data generator.

As discussed above the BI information is preferably themed BI information, and the data selection means is preferably arranged to enable selection of BI information representing a theme in the BI information from the BI application and to provide this selected data to the map generator to generate a map layer which represents the same theme.

The theme may include any BI theme. For example, in a real estate scenario, the theme may include “Price of Real Estate in Suburbs”. Such a theme may be represented in the BI application by a display of a chart or table which includes, for example, colour coding defining the prices of houses. The data selection means may enable the BI theme data representing the colours used in the theme to be selected for generation of map data.

The map data preferably includes thematic data which represents the thematics of the business information and is useful to generate map representation expressing the same themes as the BI application. For example, the thematic information may include the legend of the chart or graph, the map representation expressing the same data spatially using the same colours, etc.

The data selection means preferably includes a data selection interface which is arranged to enable a user to configure the data selection means to select themed BI information from which map data is to be generated, so that the map representation will be generated from the selected themed BI information. For example, the data selection means may be arranged to select as the themed BI information, themed BI information from a display being displayed by the BI application, so that the map representation will be a map representation of BI information from a display that the user is looking at at the time. The user can then move between the BI display and the corresponding map representation.

Preferably, the map manipulation means includes a map manipulator interface, which is preferably arranged to display the same “look and feel” as the BI application. For example the colours used for non data parts of the map manipulator may be the same as those used in the BI application. Business logos may also be used in the map manipulator if they are used in the display of BI information. Preferably, the map data includes “look and feel” data, for use by the map generator to enable generation of the same “look and feel” by the map manipulator. Note that the thematic data generally describes the representation of data (ie in the map), while “look and feel” data controls how the rest of the application looks (eg the logos, colours used for non data parts of the interface, etc). Preferably, the map manipulator enables manipulation of the map representation eg selection of map data, zooming, panning, etc.

In one embodiment the map data includes auxiliary data, the auxiliary data representing auxiliary information which may be associated with the map representation. For example, the auxiliary information may include a link which is arranged to appear on the map representation, the link being arranged to connect to business information associated with the link. Auxiliary information may also “pop-up” or otherwise be displayed when a user moves the mouse pointer over a point on the display.

The map data generation means is also preferably arranged to provide location data. The location data may be in longitude or latitude form where this is available in the BI information. Alternatively, the location information may include other location information, such as street address. A Geocoder may then be used to provide the longitude or latitude information for the map generator.

In accordance with a second aspect, the present invention provides a method for computer generating a map representation of information from a business intelligence application implemented on a computing system, the method comprising the steps of generating map data from business intelligence (BI) business information from the business BI application, and utilising the map data to generate a map representation of the BI information, which map representation may be displayed by the computing system together with any base map data.

Preferably, the BI information is themed BI information. That is, the BI information represents a particular theme.

The method preferably further comprises the step of, for any changes in BI information by the BI application, causing corresponding changes in the map data, whereby resulting in corresponding changes in the map representation.

The method preferably comprises a further step of, in response to a user manipulating the map representation of the BI information, producing BI or spatial information from the manipulation and providing the BI or spatial information back to the BI application.

The step of generating map data may include the step of selecting a theme from the BI application and generating the map data corresponding to that theme so that the generated map representation will correspond to the selected theme. Preferably, the step of selecting the theme includes a step of generating map data including thematic data from which thematic information can be produced so that the map representation represents the same theme as the BI information.

The step of selecting the theme may include the step of selecting a theme from whatever BI information is appearing on the display of BI application, so that whenever a user is viewing a BI display, then map data corresponding to a theme of the BI display is generated and used to produce a corresponding map representation.

The step of generating map data may further include the step of generating auxiliary data, the auxiliary data representing auxiliary information which may be associated with the map representation. The auxiliary information may include a link which is arranged to be associated with the map representation and connect to data or another system associated with the link.

In accordance with a third aspect, the present invention provides a method of analysis of BI information generated by a BI application implemented on a computing system, the method comprising computer generating a map representation from BI information, carrying out a manipulation of the map representation to produce further BI information that is returned to the business intelligence application, and generating a further map representation utilising the further business intelligence information.

The further BI information may include spatial information.

Further manipulations of the map representation may lead to production of yet further BI information and corresponding generation of changes to the map representation. The analyst can move between the spatial domain and the BI application to perform their analysis.

In accordance with a fourth aspect, the present invention includes a computer generated map, including a map representation of BI information, the map being generated by a system in accordance with a first aspect of the present invention.

In accordance with a fifth aspect, the present invention provides a computer programme arranged to control a computer to implement a system in accordance with the first aspect of the present invention, to generate a map representation of BI information from a BI application.

In accordance with a sixth aspect, the present invention provides a computer readable medium providing a computer programme in accordance with the fifth aspect of the present invention.

### BRIEF DESCRIPTION OF THE DRAWINGS

Features and advantages of the present invention will become apparent from the following description of embodiments thereof, by way of example only, with reference to the accompanying drawings, in which:

FIG. 1 is a schematic block diagram of a system architecture for a system in accordance with an embodiment of the present invention; and

FIGS. 2 to 37 are various examples of “screen shots” showing various displays provided by embodiments of the present invention, in order to illustrate operation of embodiments of the present invention.

### DESCRIPTION OF PREFERRED EMBODIMENTS

The embodiments of the present invention described in the following description are implemented as computing systems, including software and hardware. Any appropriate system architecture may be utilised to implement the functionality described. For example, a network architecture may be used or a “stand alone” architecture. The software may take the form of programme code stored or available from computer readable media, such as CD-ROMS, or any other machine readable medium. The computer readable medium may include transmission media, such as cabling, fibre optics or any other form of transmission medium.

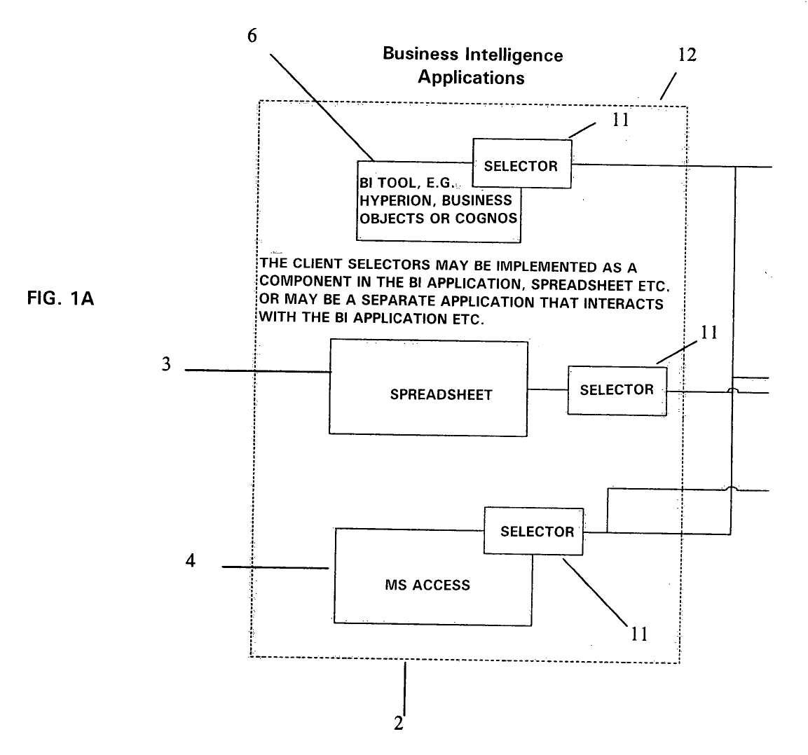

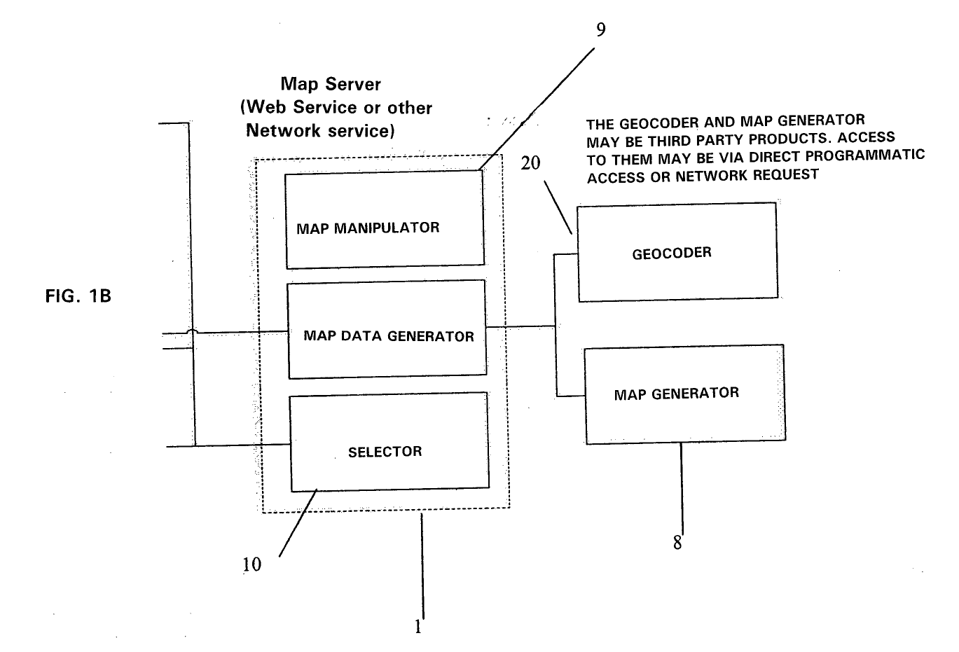

FIG. 1 shows a first embodiment of a system in accordance with the present invention. The system of this embodiment comprises a mapping server 1 which is arranged to receive business intelligence (BI) information from one of many Business Information (BI) applications (generally designated by reference numeral 2). The BI applications may include any applications which produce BI information, including a spreadsheet application 3, MS Access 4 or other BI application 6, for example Hyperion™.

In this embodiment, the mapping server 1 includes a map data generation means in this example being in the form of map data generator software 7 which is arranged to receive BI information from one or more of the BI applications 2 and generate map data which is useable to generate a map representation of BI information. In this example, the BI information is themed BI information. That is, the BI information represents one or more themes.

The mapping server 1 has access to a map generator 8, in the form of a system arranged to generate a map representation utilising map data provided by the map data generator 7, together with any base map data. The map generator 8 may be a third party GIS product accessed via direct programmatic access or over a network via network request. Alternatively, the map generator 8 may be incorporated in the map server and may be part of the present system.

Map manipulator software 9 is arranged to enable a user to manipulate the map representation, for example by selecting map data, zooming, panning or extra business rules. Data selection means 10, 11 enables exchange of data between the BI applications and the mapping server 1. The data selection means 10, 11 enables BI or spatial information produced from map manipulation to be returned to the BI applications 2, as well as themed BI information from the BI applications to be provided to the mapping server 1.

Either the BI applications include components implementing a data selection means, in this example being in the form of selector software 11, or a separate system interacts with the BI application for example through COM to implement the data selector means. Selector software 11, is arranged to enable selection of the BI data for providing to map data generator 7 so that the map representation will be generated from the selected BI data. In the preferred embodiment the selector software 11 is arranged to select data corresponding to one or more themes in the BI application. For example, the selector software 11 may select as the themed BI information to be provided to the map data generator 7, the themed BI information corresponding to a particular chart being displayed by the BI application 2. The selector software 11 includes a data selection interface (see later) by way of which a user may configure the selection software to select desired data.

Further selector software 10 is provided in the mapping server 1 in order to select BI information which may be produced by map manipulation, or spatial information from map representation, for transmission to the BI application.

In order for the correct positional information to be provided to map generator 8, if such positional information isn't available as longitude and latitude information in the BI, then a connection is provided by the mapping server 1 to a Geocoder 20 so that BI information in the form of street address, for example; can be translated by the Geocoder 20 into longitude and latitude information for the map generator 8 to be able to generate a map. The Geocoder may be a third party product accessed over a network or by direct programmatic access. Alternatively, the Geocoder may be incorporated into the present system and included in the map server.

A detailed description of operation of the embodiment of FIG. 1 will now be given.

The selector software 11 in this embodiment operates to select BI information in accordance with a BI theme, and provide themed BI information containing this to the map data generator 7 to produce map data in accordance with the theme. For example, a theme can be automatically selected from a chart in a BI document as long as the selector sofware 11 is configured to do this. A BI chart may, for example, have a theme “Houses Sold by Property Type”. If this theme is selected by the selector 11, then the appropriate BI data for the theme (as represented by the chart) is selected by the selector 11 and the themed BI information for that theme is used by the map data generator to generate map data for a map representation in accordance with the same theme.

The map representation is generated as one or more “map layers” which may then be transposed over base map data (for example a standard geographical map representation). The selector 11 is arranged to switch between BI themes as will be described in more detail later.

The ability to select themes allows a user to focus on particular BI information and view it in the spatial domain.

In the embodiments of FIG. 1, the themed BI information is transferred to the mapping server 1 by the BI application making an http request to the mapping server 1. The request contains all the information needed to fulfil the request and to generate map data (by the map data generator 7) which can be used by a map generator 8 to generate a map layer corresponding with the themed BI information.

There are three alternative mechanisms which may be utilised to send the http request. In a first method, a html file containing a post request is written to disk and then a browser is started with this file as a start-up parameter. The browser loads the html file and automatically sends the request to the mapping server 1. In the second method the request is formulated within the BI application and the browser is started with the request as a parameter. The third method involves sending a direct http request from within a browser environment and having results appear in the same or another browser window.

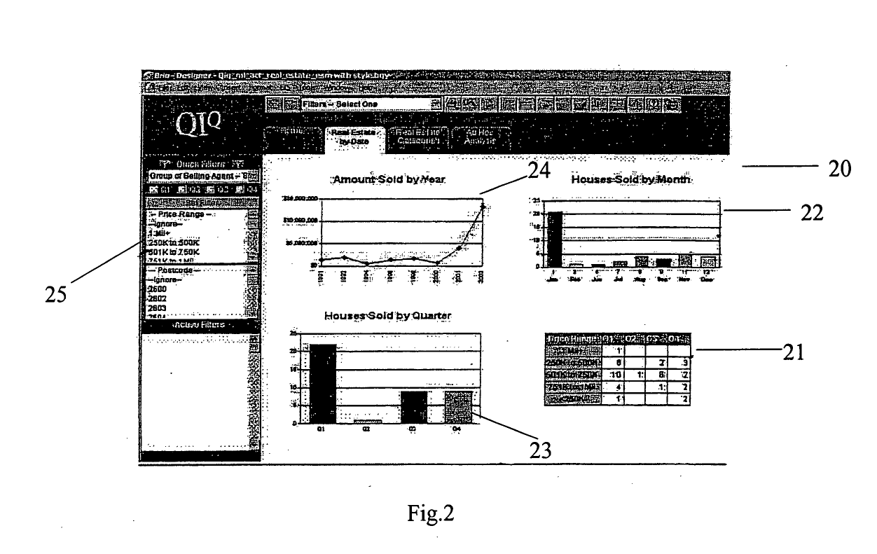

FIG. 2 is a “screen shot” showing how data is presented by a typical BI application. In the screen shot 20, the data relates to house sales. The data is in-turn displayed in table form 21, chart form 22, 23 and graph form. Data can be displayed in many other formats by typical BI applications. Each of the formats in FIG. 2 can be considered to define a “theme”. For example, chart 23 has the theme “Houses Sold by Quarter”.

FIG. 2 also displays an interface enabling a user to set a Filter 25 for the various BI data.

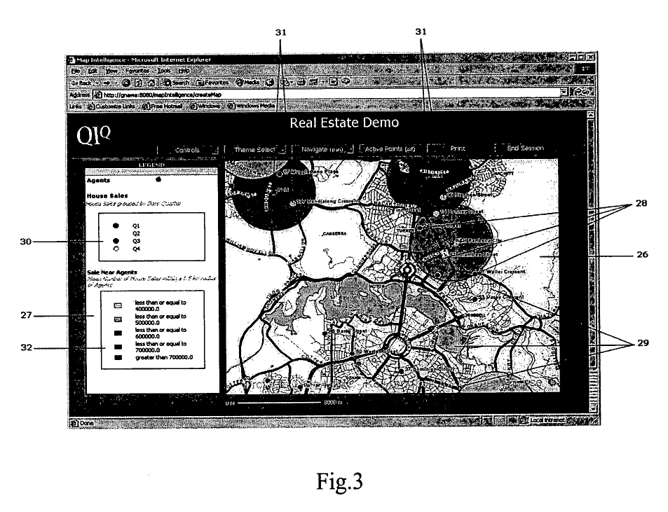

FIG. 3 is a screen shot of a map representation produced by an embodiment of the present invention, and including a map layer which is generated in accordance with themed BI information in accordance with a selected theme. The display includes a map representation 26, and a key 27 which gives metadata 30, 32 indicating what the various symbols and colours used in the map represent.

The map representation 26 shows point data 28 which has been colour coded according to the year quarter in which the depicted event occurred. In this case, the theme of the chart “Houses Sold by Quarter” of the chart 23 of FIG. 2 is produced as a corresponding map representation, as the points 28 overlaying basic map data (streams, rivers, and other geographical locations 29). Key table 30 indicates which corresponding coloured points represent which quarter.

In operation, the selector 11 is arranged to select the appropriate themed BI information required for the map data generator to generate map data for a map representation reflecting the theme of the chart 23 in the BI application. The map data generated will include thematic data which facilitates the representation of the theme of the chart 23 in the map representation 26.

The point form colours 28, correspond to the colours used in the chart 23. The inclusion of theme data in the map data facilitates expression of the same theme in the map representation 26 as in the BI application.

The themed BI information also includes “look and feel” data which in this case includes colour data which corresponds to the logo and the same colours as used in the BI application for non data areas. This facilitates a common application look to both the BI application and the map manipulator where logos the same and non data areas use the same colour scheme.

Another BI theme is also shown in the map representation 26 of FIG. 3. Circles 31 are colour coded to illustrate the mean value of house sales within a given distance from given points (in this case distance from Real Estate Agents). Corresponding key 32 is provided. The map data for this theme is generated in a similar way for the House Sales by Quarter theme, from the appropriate BI data in the BI application 2. Map representation 26 also shows a further feature of the invention, being the ability to superimpose map layers so that more than one theme can be displayed at any one time, together with any base map data. In the example of FIG. 3 the themes Houses Sold by Quarter and Sales Near Agents are shown together.

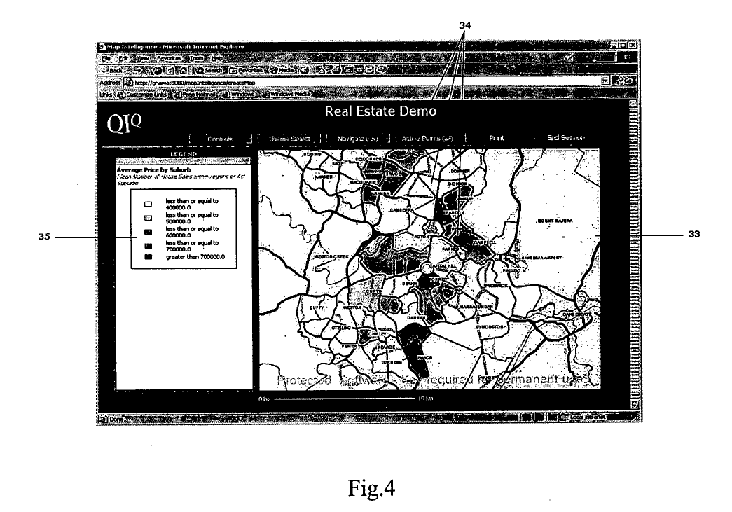

FIG. 4 is a map representation illustrating a further “real estate” BI theme. The map representation 33 also includes a map layer which represents BI of an “Average Price by Suburb” theme. The theme utilises thematic data which represents and illustrates the average prices using coloured polygons 34. The key 35 identifies what range of house price each colour represents.

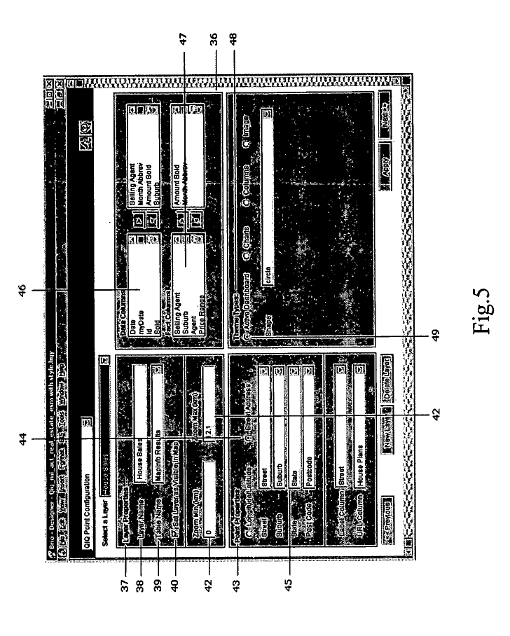

It can therefore be seen that with the present invention a BI theme can be represented in a spatial domain as a map representation. Themes from which to produce map representations can be defined in this embodiment by appropriate configuration of a data selection interface which will now be described with reference to FIG. 5.

A data selection interface, one example screen shot 36 of which is illustrated in FIG. 5, enables a user to define the BI data to be selected by the selector 11 for generating map data (and therefore ultimately generating a map layer).

The data selection interface enables configuring of the BI data set to use the condition under which the layer will be visible, the method of geolocating each point, the data field to use as a label for each point, the BI data columns that are sent to the data generator 7, and thematic data to be used.

Referring to FIG. 5, “Layer Properties” 37 allow definition of a “Layer Name” 38, in this case “House Sales”. Layer Properties 37 also allow designation of the BI Table Name 39, in this example being “MapInto Results”. A checkbox 40 allows the user to determine whether the map layer will be visible in the map by default. The zoom level set 42 allows a user to specify the zoom levels at which data should be displayed.

The method of geolocating each point in the map layer is defined by the Point Properties selector 43. In this example, Street Address 44 is selected as the method for geolocating the point data. The Street Address 45 is then defined for each of the points from the BI data. This BI data is provided to a GI coder 20 which provides the longitude or latitude information which can be used by the map generator to generate a map.

BI information to be sent to the map data generator 7 is selected by Data Column selector 46 and Fact Column selector 47.

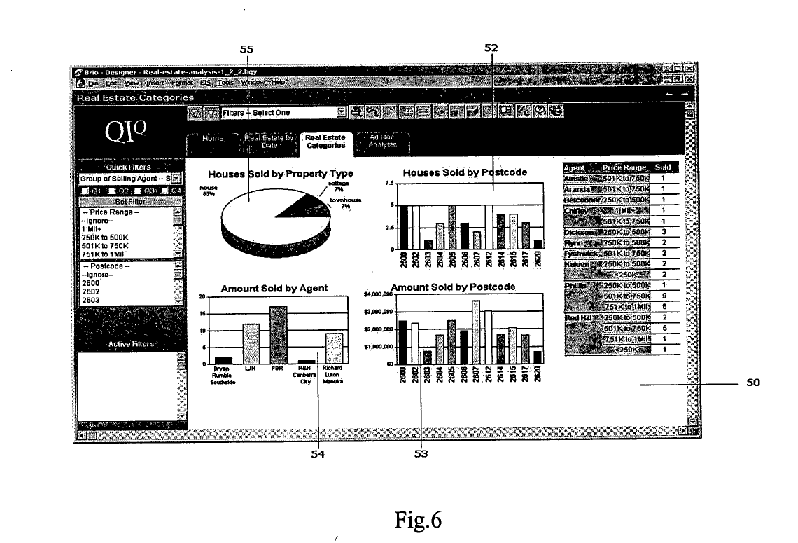

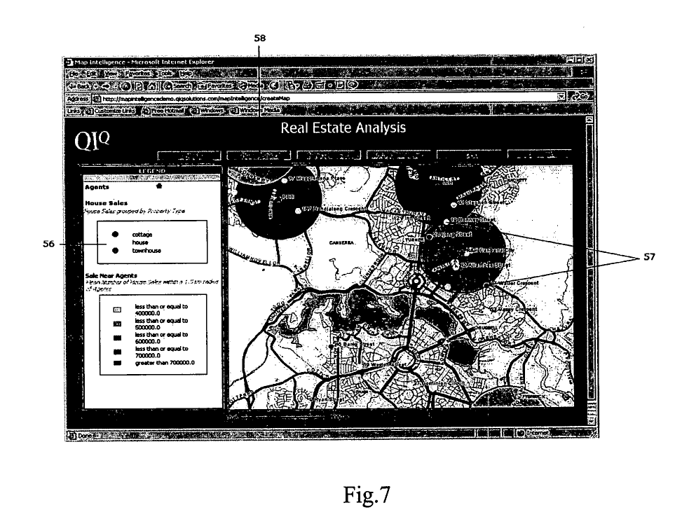

Finally, the Theme Type select 48 enables selection of how the information is to be themed. In this case the selection of “Active Dashboard” 49 configures the selector to automatically obtain data and themes based on the charts or pivots or tables that the user is currently looking at in the BI application. This operation is illustrated in the examples of screen shots of FIG. 6 and FIG. 7. Referring to FIG. 6, the BI application is displaying a screen 50 with four charts 52, 53, 54 and 55. Each of charts 52, 53, 54 and 55 have a theme relating to real estate sales. Using the selector interface (similar to the FIG. 5 example), BI information is selected for generation of a map layer. In this example, the selector software 11 is configured by the interface to select “Active Dashboard” so that map layers are automatically generated corresponding to the charts 52, 53, 54 and 55 being generated as a display by the BI application.

In FIG. 7, a map layer is displayed which corresponds to the chart 55 “Houses Sold By Property Type” 55 displayed by the BI application. The BI information is displayed as point data 57, in accordance with key 56 using corresponding theme data as used in the chart 55. In this instance the same colours are used for “cottage” “house” and “town house”.

The user can use a theme select pulldown 58 provided by the mapping server to switch between the themes associated the charts 52, 53, 54 and 55 in FIG. 6.

As discussed above, in order to facilitate an analysis of information, the system of the present invention includes data selection means 10, 11 which enables data to be exchanged between the BI application and the mapping application so that data can be manipulated in both the mapping application and the BI application. A user can therefore carry out an analysis using both domains (the spatial domain of the mapping environment and the BI domain). This greatly facilitates analysis.

For example, one “Analysis Flow” using an embodiment of the present invention may involve the selection of BI data which can be used by the map generator to produce a map display representing themes illustrated on a BI application dashboard. The map generator displays, for example, the data as a coloured coded points or shaded areas in a map layer. The user can then select (via map manipulator 9 and selector software 10) part of the display data or can select other map data (for example basic geographical data) that becomes interesting because of the data sent from the BI application. This selected data can then be made available (via selector software 10) back to the BI application via a web service, for example, indexed by the common session key. The BI document can then call the web service and retrieve the data which is then used to perform further analysis within the BI environment.

The following are examples of simple analyses that could be performed using this embodiment of the present invention.

### EXAMPLE 1

A dashboard (BI application) is used to display various ways of looking at accidents in the last month. For example by car type, by time of day, by age of driver, by weather conditions. The dashboard cannot show “accident black spots”. To do that we send these accidents to the mapping server for spatial analysis. High concentrations of accidents are easy to see on the map view. Groups of such “proximate” accidents are then selected from the map—an accident black spot. These are retrieved by the BI application which then can focus on those accidents and provide an in depth analysis of just the accidents that took place at one or more “black spots”. These accidents could not have been selected in the BI dashboard because the dashboard lacks spatial semantics, and a report showing the distribution of accidents by driver age could not be produced from the map.

### EXAMPLE 2

The accidents are sent to the mapping server as in Example 1. Instead of selecting sets of accidents however, this time the user selects the road junctions that are the black spots as indicated by the high concentration of accidents in the last month i.e. selecting base map data. These are retrieved by the BI application and are used to generate a new query and report that shows how the concentration of accidents has varied over a time span that goes beyond the last month (the extent of the original query) at these junctions and how maintenance work carried on at these junctions affect the levels of accident.

In both of these examples we are using information that is available in one or other domain, but not both to get insights that would be difficult to get from using either domain on its own. The ability to select flexibly in either medium and use the selection criteria to modify the “partner” application (map or BI application) provides great power that is not available otherwise. This is especially true because the system keeps the two types of analysis synchronised. Each time the user sends information from the BI tool to the map server, the last area of interest on the map (such as centre point, map width or layers displayed) can be retained so that the analysis of the new data is an extension of the previous spatial analysis. Similarly the mechanism for providing the BI application with data selected in the spatial environment can enable the user to further continue and specialise their BI analysis in the BI environment.

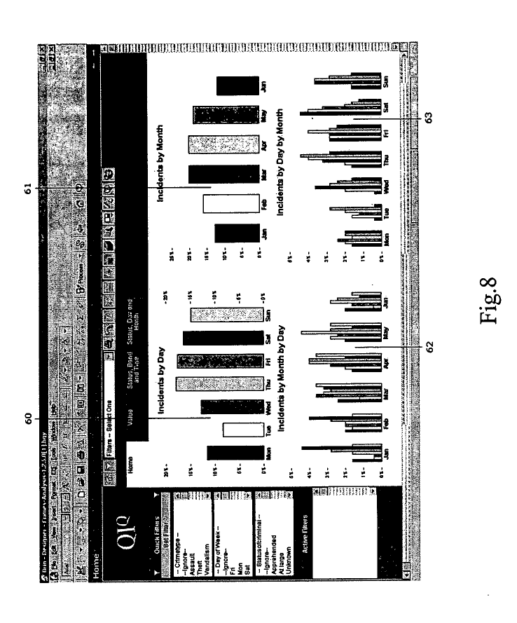

FIGS. 8 to 16 are various “screen shots” of a system in accordance with an embodiment of this invention, based on an example of BI information which relates to crime. This example further illustrates how a user may switch between a spatial domain and BI application domain to facilitate their analysis of BI.

FIG. 8 illustrates a “dashboard” that provides some analysis of crimes in a city (note that all figures used in this example are fictitious). The dashboard shows four different themes illustrated by coloured charts, including Incidents by Day 60, Incidents by Month 61, Incidents by Month by Day 62 and Incidents by Day by Month 63.

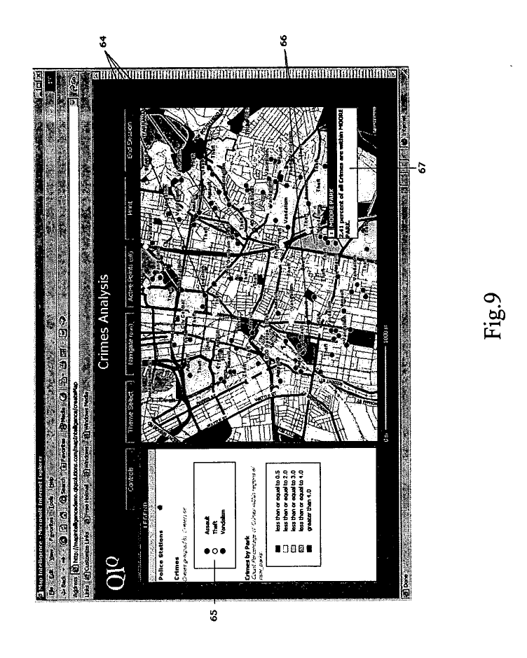

FIG. 9 shows a map representation of information taken from the crime BI, in this case point data 64 representing types of crimes 65 and shaded area data 66 which indicates the proportion of crimes that occur within city park boundaries. Note that this analysis was done by the map server 1 taking into account the information provided by the BI and the spatial information to provide the analysis of crimes by park.

Table 67 is a “pop up” which shows some more information on crimes occurring in a particular one of the parks. This information will be provided by auxiliary data when the user moves a GUI icon over the park.

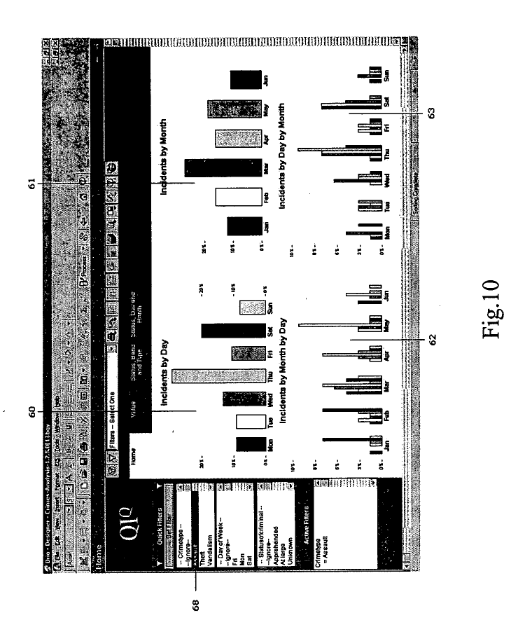

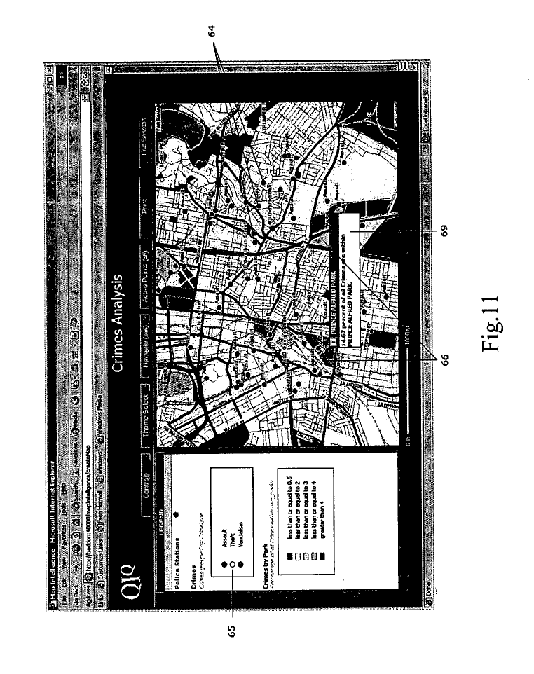

In this example, the user then decides that they wish to focus on assaults and not theft or vandalism. They return to the dashboard and set a filter 68 to focus on assaults only. The charts 60, 61, 62 and 63 then update only to show assaults (FIG. 10). The user then operates their system to redisplay the new data in map representation form (by operating a GUI button on the display). FIG. 11 shows the map representation of the updated BI. In this case the point data 64 only shows assaults, and similarly the “crimes by park” graphic 66 only shows assaults by park. Auxiliary information shows that 14.67% of all assaults are perpetrated within Prince Alfred Park.

The user then decides to use the map manipulation means to “zoom in” to the park and do some further examination.

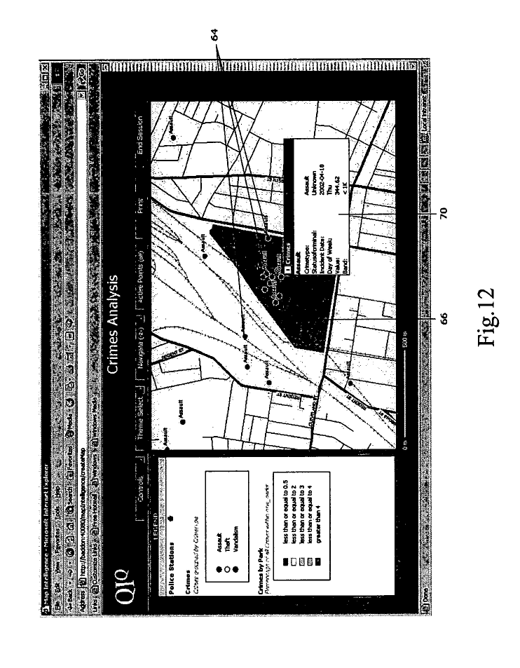

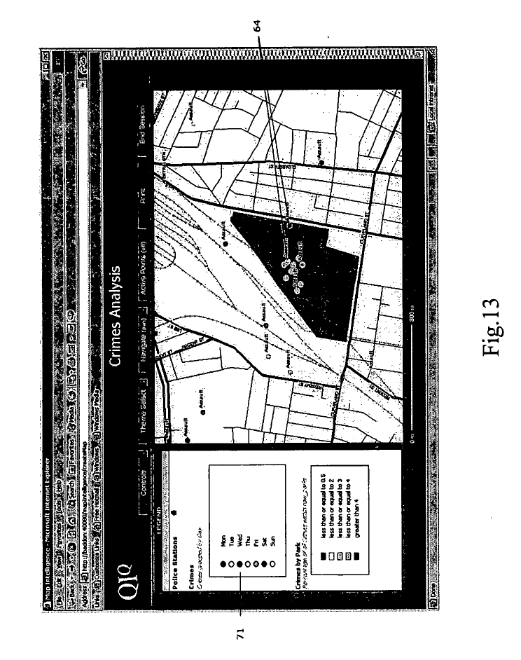

A “zoom” view of Prince Alfred Park is shown in FIG. 12. In the zoom view by placing the GUI cursor over any specific point more information is displayed. The user can see that it looks like most of the assaults took place on Thursday. The user may then wish to display the data themed by day of the week to see if all crimes occur on Thursday and FIG. 13 shows crimes themed by day of the week (the points of colour depending on day of the week) as per key 71.

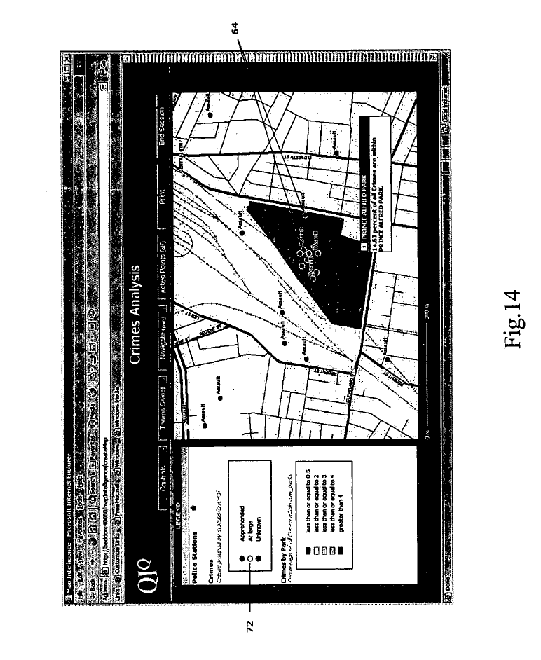

An alternative display of crimes themed by the status of the criminal is disclosed in FIG. 14. The points are this time coloured according to the status of the criminal in accordance with the key 72.

The user has discovered a collection of assaults that occur on the same day of the week in the same park and by a criminal who has not yet been apprehended. At this point the user can use the map manipulation means to select all the crimes that fall within the boundary of Prince Alfred Park. These can then be sent back to the BI application for further analysis of data associated with these particular crimes.

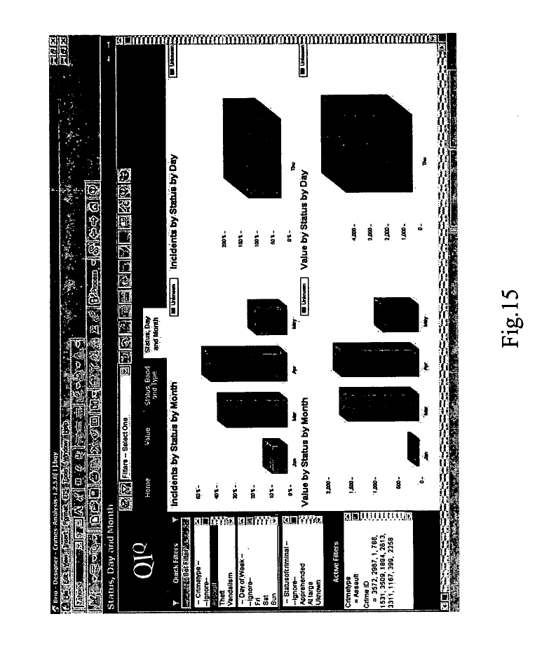

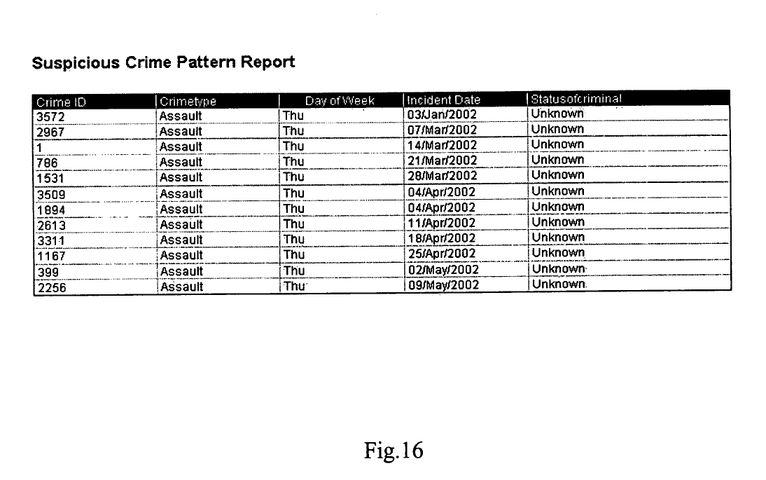

FIG. 15 shows a dashboard further filtered by the data sent back from the map, to show the assaults that take place in Prince Alfred Park. Using the dashboard the user can view the data behind the new chart representation to see the dates on which the crimes occur. This can then be passed on to a local police unit who can concentrate their efforts in a place and at a time that should provide the best chance of catching the criminal perpetrating the assaults in Prince Alfred Park. The data is shown in the “Suspicious Client Pattern Report” in FIG. 16.

The following is a description of how the layers and themes are defined for the above crimes example.

The steps involved in defining layers and themes for the crimes example are as follows. This is done once by the dashboard designer, the end user simply interacts as in the previous crimes example. It is important to note that these screens define data columns and theme data. Other selector mechanisms such as query filters that apply in the dashboard automatically apply to the data sets and charts used here and therefore automatically filter the data sent to the mapping server. An example of this would be to apply a filter of “Assaults” to crime type. This would ensure that only crime data of type assault would be sent to the map server.

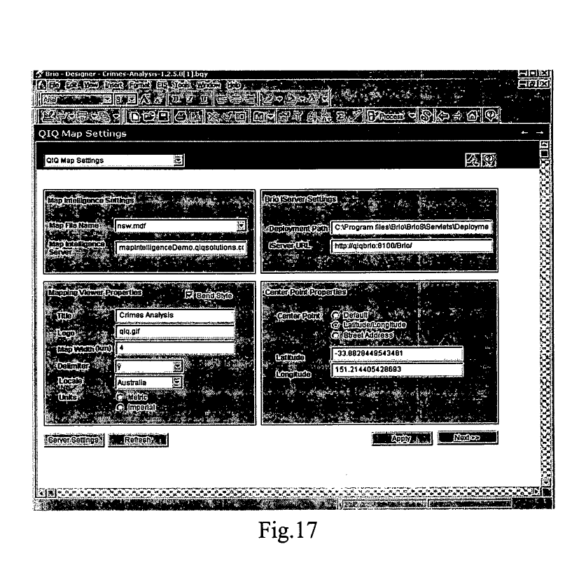

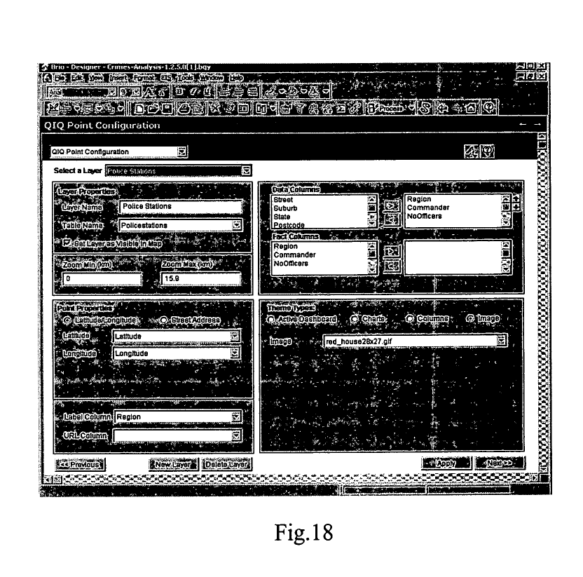

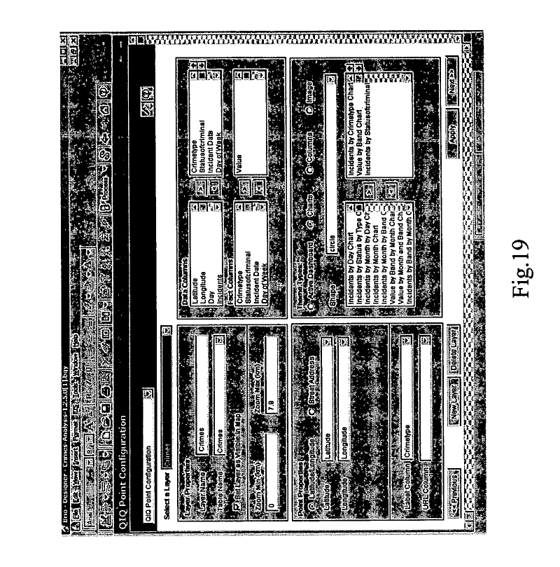

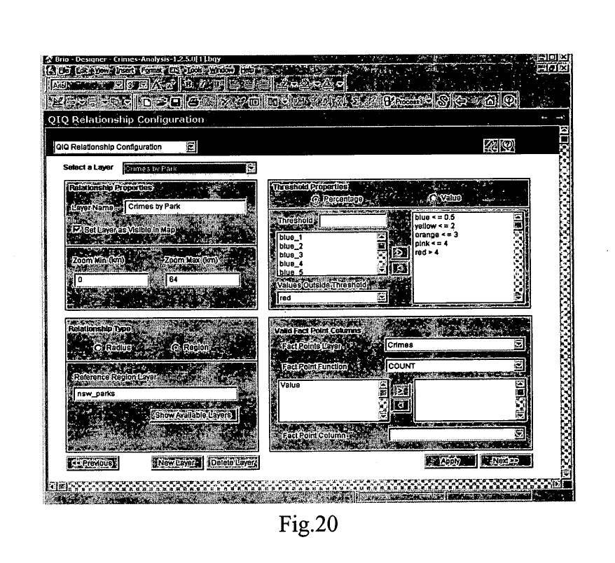

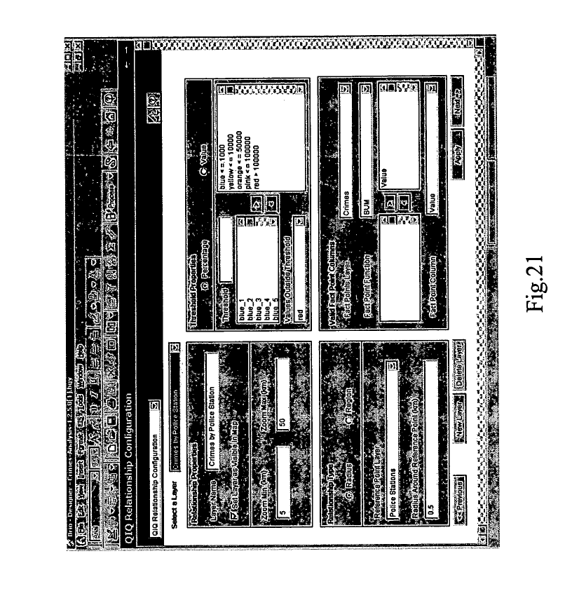

Please note that names, logos and other information are included in these drawings and in the previous drawings are not limiting to the invention. Any name or logo may be used. Note that the term “map intelligence server” refers to the mapping server 1.
1. (FIG. 17). The map settings screen allows the base map file data and the location of the map server to be specified.
   The send style checkbox defines whether the look and feel information is sent in requests to the server.
   Other information such as the logo and map manipulator title as well as country information for internationalisation and the map centre point are also specified. The centre point may be specific map co-ordinates, a street address or may be worked out automatically from the data sent in the request (default).
2. Point layer themes are configured from the point configuration selector screen (FIG. 18). This screen allows the following selection/theme information to be defined. The layer name which defines how the layer will be named in the spatial environment The table name which defines where the business information for that layer is available. Whether the layer should be visible by default. The zoom levels between which the layer is visible.
   Whether each point is geo-located as a geographic co-ordinate or by co-ordinate looked up from a street address.
   The data column that is used to label each point on the map.
   The data column to use as a link to extra data or external systems.
   Extra data columns that are sent to be used for example in the pop up windows.
   The data columns available to be used as facts in other layers such as working out the value of crimes in a particular park from the value of each crime that falls within each park (see crimes point layer, FIG. 19). The method used to theme this point layer.
   In the example they are:
   Image—where a specific icon is used to represent each point.
   Column—where values in specific columns are each associated with specific colours or icons. That is, a value of 0 to 10 could be a blue square, 10 to 20 could be a red square and above 20 could be a green square.
   Chart—where specific charts are named. These charts shall automatically be converted to themes where the colours used for point values shall be the same as those from each chart. All named charts will be sent all of the time. For each request the theme will reflect the current state of the chart or graph.
   Active chart—this is the same as chart but if this option is selected, then only the charts currently visible are used to create the request to the map server.
3. In the Police Stations point layer (FIG. 18), each station is located by an actual coordinate set from the police stations data table. Each station is displayed on the map as a red house.
4. In the crimes point layer (FIG. 19)—crimes are located by geographic co-ordinates, and no matter which screen in the dashboard that the user is looking at, crimes are sent to the map server themed on the current state (including the effect of data filters) of charts ‘Incidents by crime type’, ‘Value by band’ and ‘Incidents of status of criminal’.
5. Relationship layers are configured in the relationship configuration selector screen (FIG. 20). In a relationship layer the Layer Name, visibility and zoom levels are the same as for point layers. The relationship type defines whether this relationship layer defines displays a theme based on a distance from a fixed point (e.g. each police station in the police stations point layer above) or calculated based on a polygon such as park boundaries. In this case we are using park boundaries and are manually defining a theme where the park is coloured based on thresholds of the percentage of all crimes in the request that fall within the park boundaries.
6. FIG. 21 shows another relationship layer that displays colour coded circles depicting the value of crimes (from the crimes point layer) that fall within a 0.5 kilometre radius from the police stations in the Police Stations point layer.

These are examples of the layers used in the crime example. Other types of layer definition types are also available.

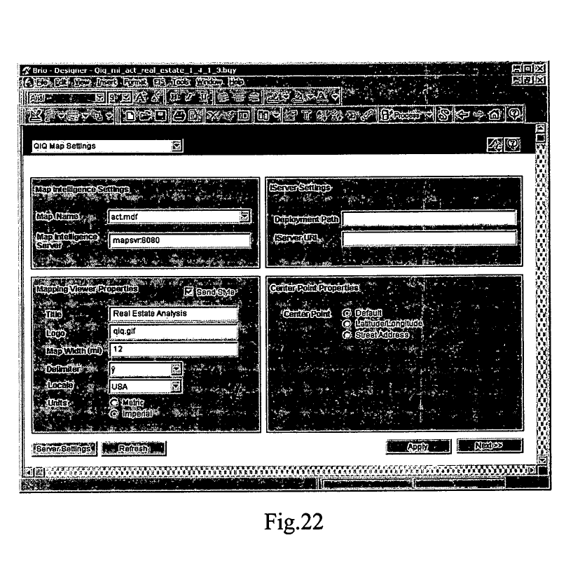

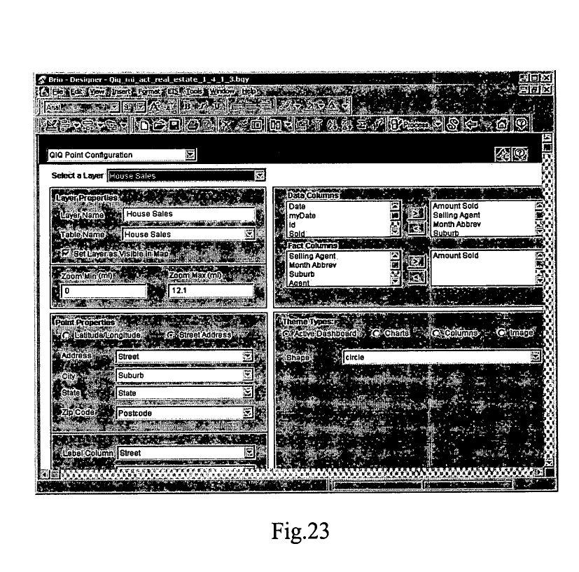

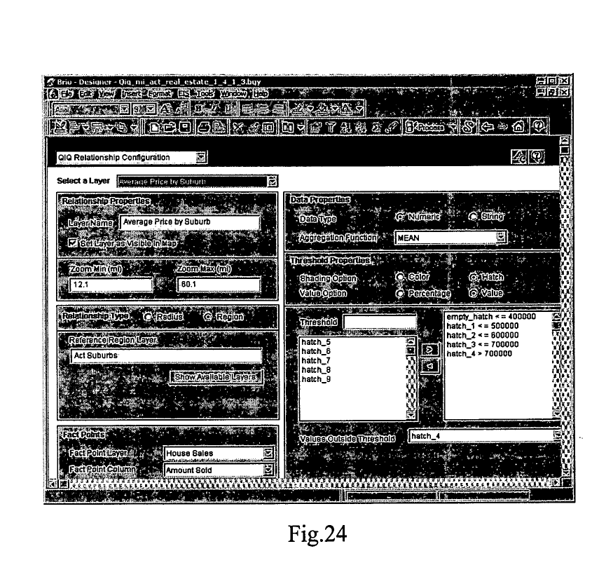

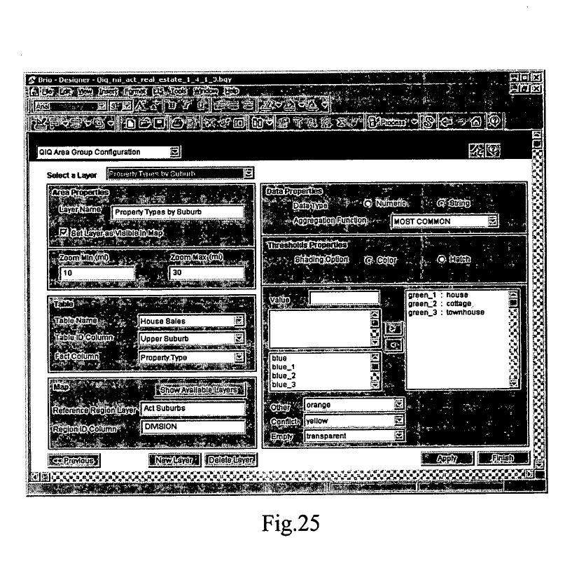

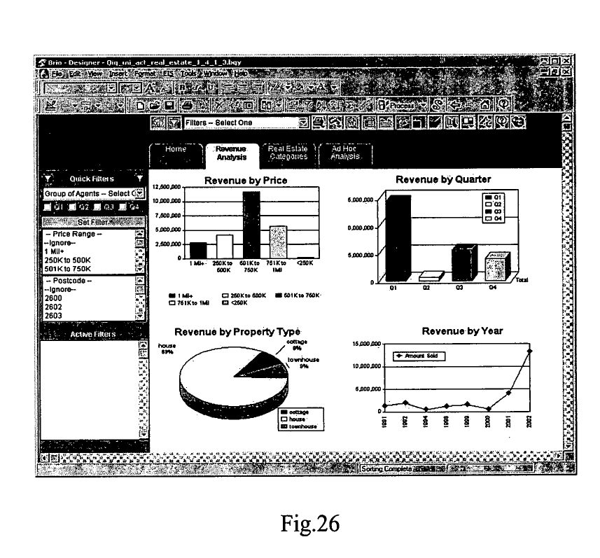

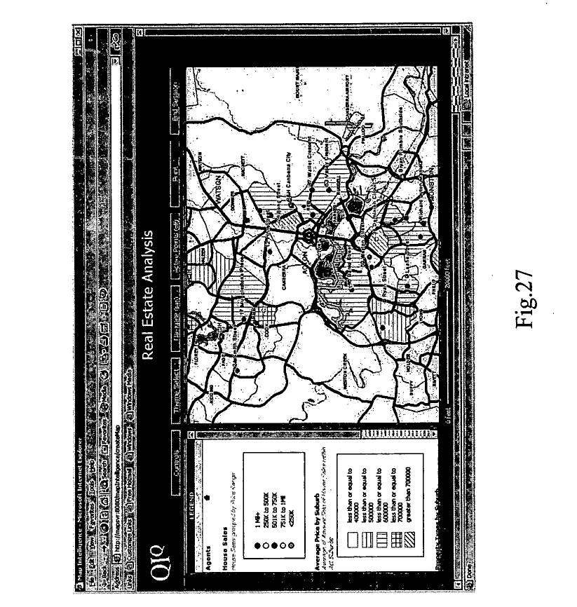

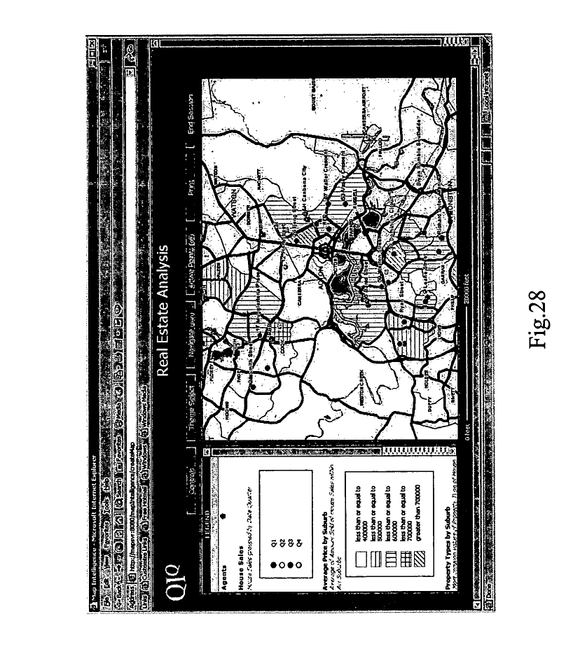

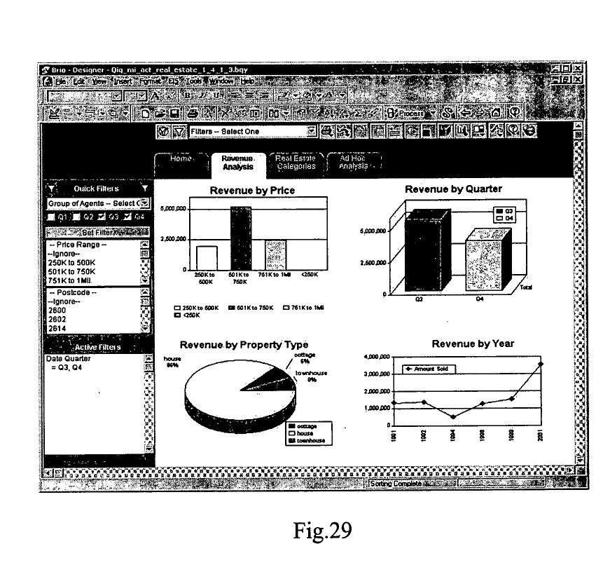

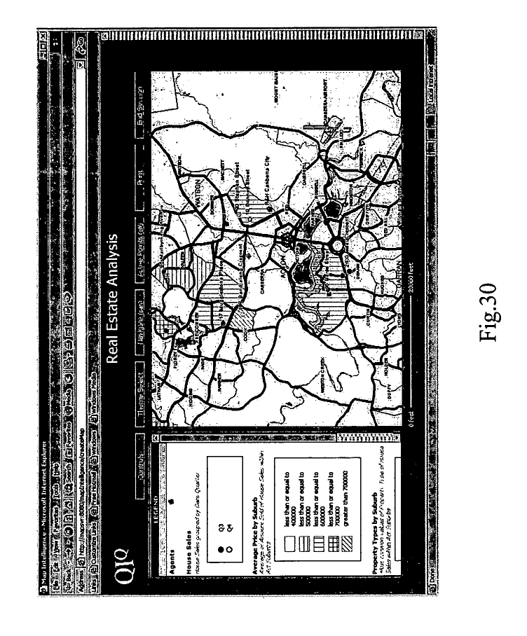

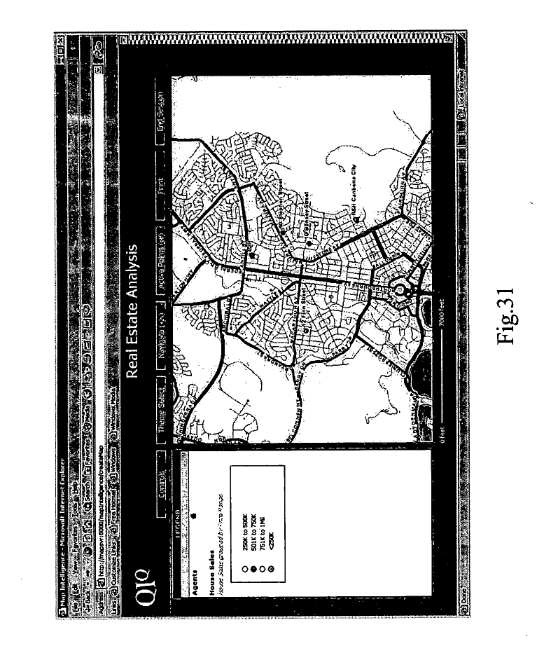

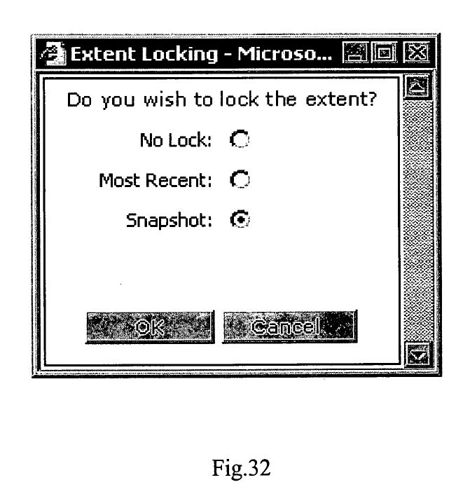

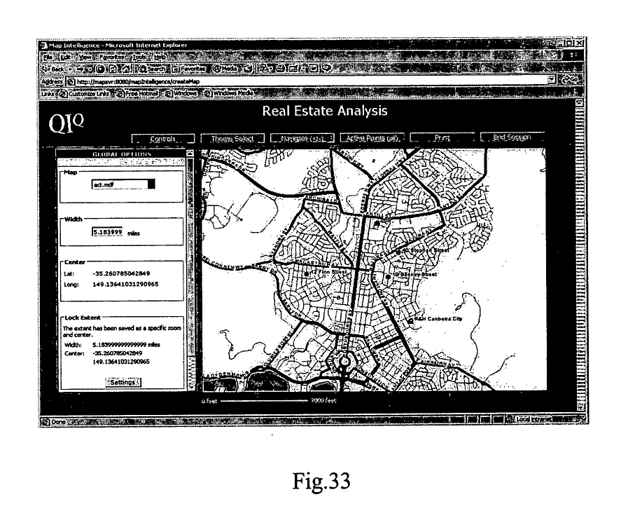

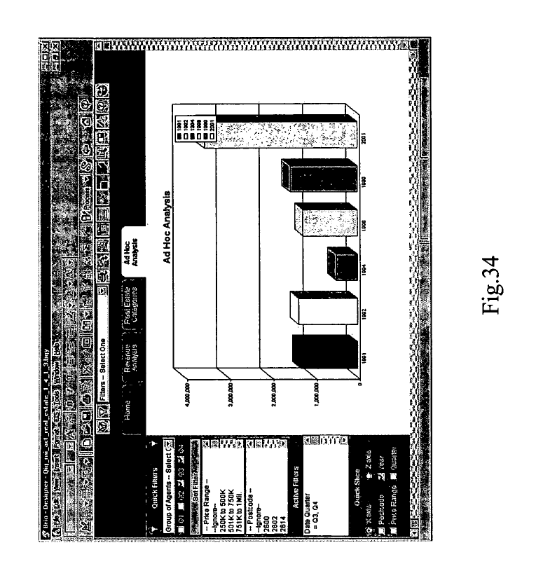

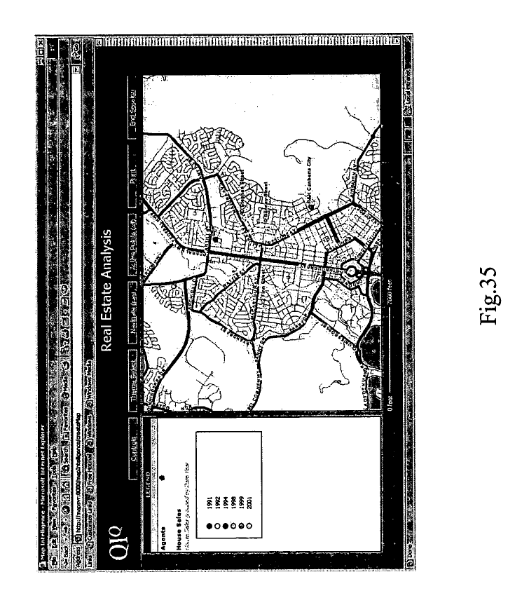

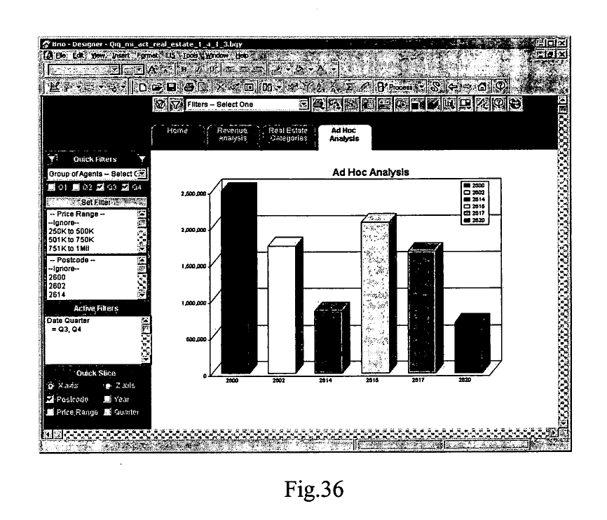

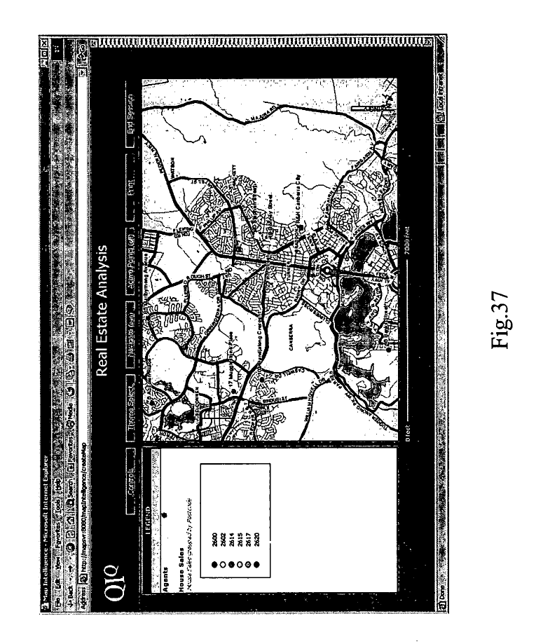

The following is a further example showing configuration and one time scenarios for a Real Estate example.
1. The dashboard designer configures the map server connection parameters (FIG. 22). In this case the map file act.mdf on server mapsvr on port 8080 is used. The title will be “Real Estate Analysis”, the look and feel info shall be sent to the mapping server, and the logo is qiq.gif.
2. The dashboard designer configures a point layer depicting house sales (FIG. 23). This layer will be visible by default, shall use the “House Sales” data table in the (in this case) Hyperion document and shall be visible from 0 to 12.1 miles zoom. Each data row shall be geocoded based on address data, each point on the map shall be labelled with the data in the street column, auxiliary data will be sent as defined in the data columns, and the value in amount sold shall be made available to be used in relationship layers. The selection of “active dashboard” means that themes shall be automatically calculated based on any charts or graphs being displayed on the page the user is looking at when they issue the map request.
3. The dashboard designer configures a relationship layer (FIG. 24) to show the average house price by suburb. This layer will appear at zoom levels between 12.1 and 60.1 miles, shall use the “ACT Suburbs” base map layer from the act.mdf map file that we specified in the map server connection screen above. This layer shall be displayed with hatches based on the “Amount Sold” column made available from the “House Sales” layer defined above. The hatch shall depict the mean value of house sales that fall within each suburb area. The actual hatch used shall be controlled by the threshold values specified.
4. Next the dashboard designer creates an area group layer (FIG. 25) to depict the type of properties sold by suburb. An area group layer is different from a relationship layer in that points (house sales) are associated with the area (suburb) by comparing the suburb field in the house sales suburb column to the suburb name in the map file. In a relationship layer this association would be based on whether the co-ordinates of the house fall within the suburb boundaries in the map file. This new layer shall be visible at zoom levels between 10 and 30 miles, it shall use the “property Type” value from each house sale row to colour code the ACT Suburbs map layer such that the most common property type defines the colour to be used. In this case colours green_1, green_2 and green_3 are used to show the most common property type by suburb.
The non mapping dashboard build steps are not shown here. The dashboard designer then publishes the dashboard for end user use.
5. The end user opens the dashboard and navigates to the “Revenue Analysis” page (FIG. 26). There are three charts and a graph on this screen. Because we are using the active dashboard setting for theme selection, the four point themes for house sales should be transmitted to the map server if the map button is selected.
6. When the user selects the map button (the top right button with the globe on in this case ref. numeral 100), a request containing themed business information is sent to the map server. The map of FIG. 27 is displayed in the map manipulator. We can see House Sales as points by price range which is one of the charts on the dashboard page. Also we can see Suburbs hatched by average price and coloured by property type as configured above by the dashboard designer. To select one of the other point themes (there should be four because we are using active chart) the user can select the themes drop down menu and select one from there.
7. The user selects House sales by Date Quarter from the theme menu and the map of FIG. 28. The legend now displays quarters coloured with the same colours as used in the revenue by quarter chart. The user can similarly view the other two themes in this manner. If the user wishes to concentrate on house sales in quarters 3 and 4, then they can return to the dashboard and add a filter on Q3 and Q4. The dashboard changes to only display house sales from Q3 and Q4 (FIG. 29).
8. If the user selects the map button again, then the map is redisplayed with only Q3 and Q4 data displayed (FIG. 30).
9. The user may then decide to zoom into an area of interest and look at price range. Using the navigate menu and then theme menu on the map manipulator they come to the view shown in FIG. 31. Note that the change in zoom levels has caused the suburb colouring and shading layers to be hidden.
10. If the user then decides that this area is of particular interest, they can lock (FIG. 32) the map extent to ensure that subsequent request from the dashboard result in this part of the map being displayed. This results in the centre point and coordinates being locked for subsequent requests. This is shown in the bottom left corner of FIG. 33.
11. If the user then returns to the dashboard they can do further analysis for this area. The user returns to the dashboard and moves to the Ad Hoc Analysis page (FIG. 34). There is only one chart on this page and therefore Active Chart will only produce one theme for this page.
12. If the user now selects the map button, the map manipulator shall display a single theme of house sales by year (FIG. 35), but only for the extent locked above.
13. The user may then return to the dashboard and change the chart to display post code rather than year (FIG. 36).
14. If they select the map button now, then because active chart is automatically creating the theme from the chart, the theme sent to the map will show house sales by post code coloured the same way as the chart (FIG. 37).

In the above described embodiment, a number of specific themes have been used as examples, specifically using “real estate” and “crimes” as examples. It will be appreciated that the present invention is not limited to these. Any theme that is available in any BI application or BI data may be used to generate a map representation in accordance with the present invention.

Further, although in the preferred embodiment map layers represent themes presented by BI applications, such as themes presented BI dashboards, the present invention is not all limited to this. The present invention enables any BI data that may be selected to be produced as a map representation, and the BI data may not necessarily have a particular theme to it. The map layer could be produced, for example, from selected BI data which is not necessarily related by the particular theme.

Modifications and variations as would be apparent to a skilled addressee are deemed to be within the scope of the present invention.

1. A system for generating a map representation of information from a business intelligence (BI) application, the system comprising map data generation means which is arranged to receive BI information from the business intelligence application and to produce map data from the BI information, the map data being usable to generate a map representation of the BI information, which map representation may be displayed together with any base map data.

2. A system in accordance with claim 1, whereas the map data generation means is arranged to provide the map data to a map generator which is arranged to generate a map representation of the BI information, together with a map representation of any base map data.

3. A system in accordance with claim 2, wherein the map generator includes a Geographical Information System (GIS) application.

4. A system in accordance with claim 2 further comprising interface means enabling a connection between the BI application and the map data generator whereby any changes in BI information produce resultant changes in map data, resulting in changes in the map representation.

5. A system in accordance with claim 4, wherein the connection enabled by the interface means is such that any changes in BI information are translated to changes in the map representation.

6. A system in accordance with claim 1 further comprising map manipulation means arranged to enable a user to manipulate the map representation of the BI information.

7. A system in accordance with claim 6, wherein the manipulation comprises selecting map representation data from the map representation.

8. A system in accordance with claim 6 wherein the manipulation comprises selecting base map data.

9. A system in accordance with claim 6 wherein the map manipulation means is arranged to produce BI or spatial information from the manipulation, which BI or spatial information may be provided back to the BI application.

10. A system in accordance with claim 9, further comprising an interface between the BI applications and the map manipulation means, the interface enabling BI or spatial information provided from a manipulation to be received by the BI application.

11. A system in accordance with claim 6, wherein a map view in the map manipulator can be synchronised for an analysis session where map manipulator settings such as the current (or user defined) zoom, centre point and layers displayed are maintained between requests from the BI application.

12. A system in accordance with claim 1, wherein the BI information is themed BI information.

13. A system in accordance with claim 1, wherein the map data includes thematic data which represents thematics of the BI information, the thematic data being useable to generate a map representation expressing the same theme as the thematics of the BI information.

14. A system in accordance with claim 13, arranged to enable a user to determine which BI theme is to be displayed as a map representation.

15. A system in accordance with claim 14, wherein map representations may be displayed for a plurality of themes at the same time.

16. A system in accordance with claim 13, wherein the thematic data that forms part of the themed business data can be automatically inferred from charts or graphs display by the BI application.

17. A system in accordance claim 16, including means arranged to enable a user to determine the Charts or graphs to be used when reproducing the theme to be displayed as a map representation.

18. A system in accordance with claim 16, wherein the charts or graphs currently being viewed by the user in the BI application can be automatically used when reproducing the theme to be displayed as a map representation.

19. A system in accordance with claim 1, wherein the themed business information includes “look and feel data” which enables the map manipulation means to express a similar look and feel to the BI application.

20. A system in accordance with claim 19, wherein the look and feel includes colours of the display of the business information, whereby the map manipulation means will express the same colour.

21. A system in accordance with claim 19, wherein the look and feel includes business logos whereby the map manipulation means will include the same business logos.

22. A system in accordance with claim 1, further comprising data selection means which is arranged to select the BI information which the map data generation means is arranged to receive, whereby the map representation will be generated from the selected BI information.

23. A system in accordance with claim 22, wherein the data selection means is arranged to select as the BI information data from a display of BI information being displayed by the BI application at the time, whereby the map representation will be a map representation of business information from the display.

24. A system in accordance with claim 22, wherein the data selection means is arranged to be user operable, whereby a user of the system may select which BI information the map data generation means receives.

25. A system in accordance with claim 1, wherein the map data includes auxiliary data, the auxiliary data representing auxiliary information which may be associated with the map representation.

26. A system in accordance with claim 25, wherein the auxiliary information includes a link which is arranged to appear on the map representation, the link being arranged to connect to business information associated with the link.

27. A system in accordance with claim 26, wherein the link is arranged to be user operable.

28. A system in accordance with claim 26, wherein the business information associated with the link is “pop up” business information arranged to appear on a user display when the link as activated.

29. A method for computer generating a map representation of information from a business intelligence application running on a computing system, the method comprising the steps of generating map data from business intelligence (BI) information from the BI application, and utilising the map data to generate a map representation of the BI information, which map representation may be displayed by the computing system together with any base map data.

30. A method in accordance with claim 29, further comprising the step of, for any changes in BI information in the BI application, producing resultant changes in the map data, resulting in changes in the map representation.

31. A method in accordance with claim 29, further comprising the step of, in response to the user manipulating the map representation of the BI information, producing BI or spatial information data from the manipulation, and providing the BI or spatial information data back to the business information application.

32. A method in accordance with claim 29, wherein the BI information is themed BI information.

33. A method in accordance with claim 32, wherein the step of generating map data includes a step of generating data corresponding to a theme of the themed BI information, whereby to generate the map representation in a form expressing the same theme as the theme of the BI information.

34. A method in accordance with claim 33 wherein the step of generating map data includes the step of generating data corresponding to a plurality of themes, whereby to generate a plurality of map representations each expressing the same theme as the theme of the themed BI information.

35. A method in accordance with claim 29, wherein the step of generating map data includes a step of generating look and field data utilising the same look and feel as the BI application to generate a similar look and feel to a map manipulator associated with the map representation.

36. A method in accordance with claim 35, where the look and feel data includes colour of the display of BI information, whereby the map manipulator will express the same colour.

37. A method in accordance with claim 35, wherein the look and feel includes business logos of the display of the BI application, whereby the map manipulator will include the same business logos.

38. A method in accordance with claim 29, further comprising the step of selecting BI information from which the map data is generated.

39. A method in accordance with claim 38, wherein the step of selecting the BI information includes the step of selecting BI information from a display of BI information being displayed by the BI application whereby the map representation will be a map representation of BI information from the display.

40. A method in accordance with claim 29, wherein the step of generating the map data includes the step of generating auxiliary data, the auxiliary data representing auxiliary information which may be associated with the map representation.

41. A method in accordance with claim 40, where the auxiliary information includes a link which is arranged to be associated with the map representation, the link being arranged to connect to business information associated with the link.

42. A method in accordance with claim 40, wherein the auxiliary information is “pop up” information arranged to appear on the map representation.

43. A method of analysis of BI information generated by a BI information application running on a computing system, the method comprising computer generating a map representation from BI information data, carrying out a manipulation of the map representation to produce further BI information data that it is returned to the BI information application, and generating further map representation utilising the further BI information data.

44. A method in accordance with claim 43, comprising the step of further manipulating the map representation and producing data which is returned to the BI application.

45. A method in accordance with claim 43, comprising the step of manipulating the BI information in the BI information application and generating the map representation from the manipulated BI information.

46. A computer generated map including a map representation of BI information, the map being generated by a system in accordance with claim 1.

47. A computer programme arranged to control a computer to implement a system in accordance with claim 1 for generating a map representation of information from a BI information application.

48. A computer readable medium providing a computer programme in accordance with claim 47.
